(19) United States
(12) Patent Application Publication
(10) Pub. No.: US 2010/0081117 A1
(43) Pub. Date: Apr. 1, 2010

(54) Personal Hygiene Tutor Device and Method

(76) Inventors: Robert Marcus, San Diego, CA (US); Tracy Francis, San Diego, CA (US)

Correspondence Address: STEINS & ASSOCIATES, 2333 CAMINO DEL RIO SOUTH, SUITE 120, SAN DIEGO, CA, 92108, US

(21) Appl. No.: 12/240,856

(22) Filed: Sep. 29, 2008

(51) Int. Cl. G09B 23/00

(52) U.S. Cl. 434/262

(57) ABSTRACT

A Personal Hygiene Tutor Device and Method is disclosed. The device provides automated prompting to tutor children and others in the proper techniques for a showering, hand washing, tooth brushing and other personal hygiene activities. The tutoring method will selectively commence once the user depresses an activation button, and will continue presenting a series of human-perceptible prompts at predetermined time intervals until the selected method is completed. The device has a water-resistant housing such that it can be placed within the shower/bath/lavatory environment. The device further includes internal speakers and/or visual indicators, and an internal power supply. The device is available in a variety of shapes and sizes to capitalize on several different market-driven application scenarios.

### BACKGROUND OF THE INVENTION

1. Field of the Invention

This invention relates generally to educational devices and methods and, more specifically, to a Personal Hygiene Tutor Device and Method.

2. Description of Related Art

Personal hygiene is a very important topic in today's environment. Children are one segment of the population that requires repeated instruction on hygiene to ensure cleanliness. Showering without adult supervision can tend to give children (and their parents) problems, as it is a learned process. In some cases, the child simply loses track of time and leaves the water running for too long of a time, resulting in waste and the corresponding negative impact to the environment In other cases, the child may not clean him- or herself sufficiently and/or may not fully rinse off soap.

Hand washing is another area of concern. The U.S. Center for Disease Control has issued hand cleanliness standards that often are not met by children. Furthermore, adults in such occupations as food service and healthcare must observe hand cleanliness in order to limit transmission of potentially harmful bacteria or viruses.

Traditionally, parents will instruct their children on the finer points of showering technique. The problem is that the parent cannot typically be present for every shower that the child takes. Similarly, hand washing “coaching” comes in the form of repeated training as well as posted signage (at least in the commercial environment) but without any active visual or audible reminders.

Even after the child has become old enough to know better, they still can tend to take overlong showers, to the great frustration of their parents. The children may simply like to stand under the hot water until there is no more left! The resulting cost and waste of clean water can be substantial.

What is needed is a device and method that can “coach” or prompt the child or other user on the technique and timing of showering, bathing and/or hand washing.

### SUMMARY OF THE INVENTION

In light of the aforementioned problems associated with the prior devices and methods, it is an object of the present invention to provide a Personal Hygiene Tutor Device and Method. The device should provide automated prompting to tutor children and others in the proper techniques for a showering, band washing, tooth brushing and other personal hygiene activities. The tutoring method should commence once the user depresses an activation button, and should continue presenting a series of human-perceptible prompts at predetermined time intervals until the selected method is completed. The device should include a water-resistant housing such that it can be placed within the shower/bath/lavatory environment, internal speakers and/or visual indicators, and an internal power supply. The device should be available in a variety of shapes and sizes to capitalize on several different market-driven application scenarios.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1 is a front perspective view of a first preferred embodiment of the shower tutor device of the present invention;

FIG. 2 is an exploded rear perspective view of the device of FIG. 1;

FIG. 3 is a front perspective view of a second preferred embodiment of the shower tutor device of the present invention;

FIG. 4 is a bottom view of the device of FIG. 3;

FIG. 5 depicts the administrative user control features and settings of the device of the present invention; and

FIGS. 6A and 6B depict one of the preferred shower prompting methods of the present invention.

### DETAILED DESCRIPTION OF THE PREFERRED EMBODIMENTS

The following description is provided to enable any person skilled in the art to make and use the invention and sets forth the best modes contemplated by the inventors of carrying out their invention. Various modifications, however, will remain readily apparent to those skilled in the art, since the generic principles of the present invention have been defined herein specifically to provide a Personal Hygiene Tutor Device and Method.

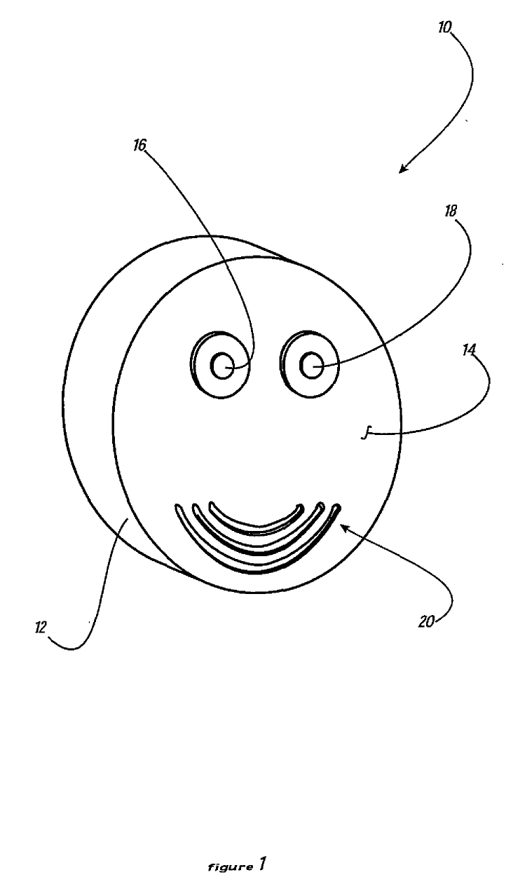

The present invention can best be understood by initial consideration of FIG. 1. FIG. 1 is a front perspective view of a first preferred embodiment of the shower tutor device 10 of the present invention.

The device 10 has a housing 12 that is designed to be substantially water-proof, or at least water-resistant enough to prevent water from entering the interior of the housing 12 and damaging the electronics located therein. The face 14 of the housing 12 in this version may be designed to resemble a smiling human face in order to entertain the young user. Housings 12 having other shapes or orientations may also be available.

In this depicted version 10, there is a first activation button 16 and a second activation button 18. The two separate buttons 16 and 18 would enable the device 10 to provide two distinct prompting sequences. For example, activating the first button 16 may cause the “beginner” method of shower tutor prompting to commence, while activating the second button 18 may cause an “intermediate” or “advanced” method of shower tutor prompting to commence. In other versions, the user may be provided with either additional buttons, or even multi-function buttons. Single-function buttons are most likely preferred in order to simplify the operation of the device 10 for the younger users. The buttons 16, 18 and speaker grill 20 are designed to prevent liquid penetration into the interior of the housing 12.

The device 10 has electronics contained within the housing 12 to provide audible tutoring/prompting/coaching to the user regarding the steps and timing involved in showering (or, alternatively, bathing or hand washing). The device 10 may also be provided with some element for attachment to an exterior surface, such as adhesive patches, hooks or string for hanging. The device 10 may also be rested on a flat surface.

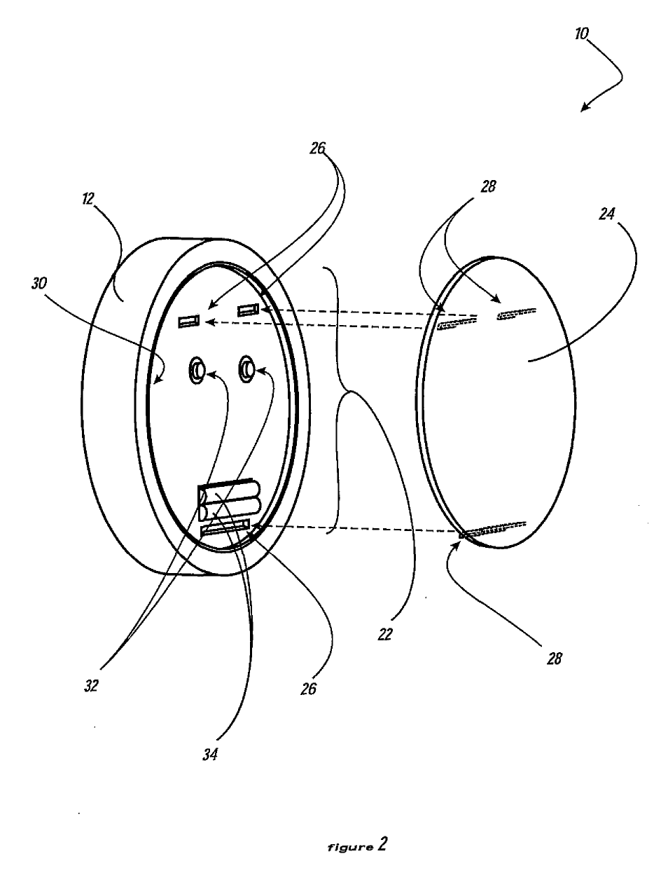

FIG. 2 is an exploded rear perspective view of the device 10 of FIG. 1, supplied to provide additional detail regarding the functional elements of the device 10. The housing 12 has a recessed control compartment 22 that is accessible through the rear of the housing 12. The control compartment 22 has a cover plate 24 that snaps into place over to cover it. The cover plate 24 has a plurality of cover latch fingers 28 on its inner surface. The fingers 28 are cooperatively located so that they will engage latch receptacles 26 located within the control compartment 22. The cover plate 24 is held in place to cover the control compartment 22 by snapping the latch fingers 28 into their corresponding latch receptacles 26.

A gasket seal 30 surrounds the periphery of the control compartment 22. The seal 30 is squeezed between the cover plate 24 and the rear of the housing 12 when the cover plate 24 is closed; this will substantially keep all of the water from the shower, bath or sink from penetrating into the control compartment 22.

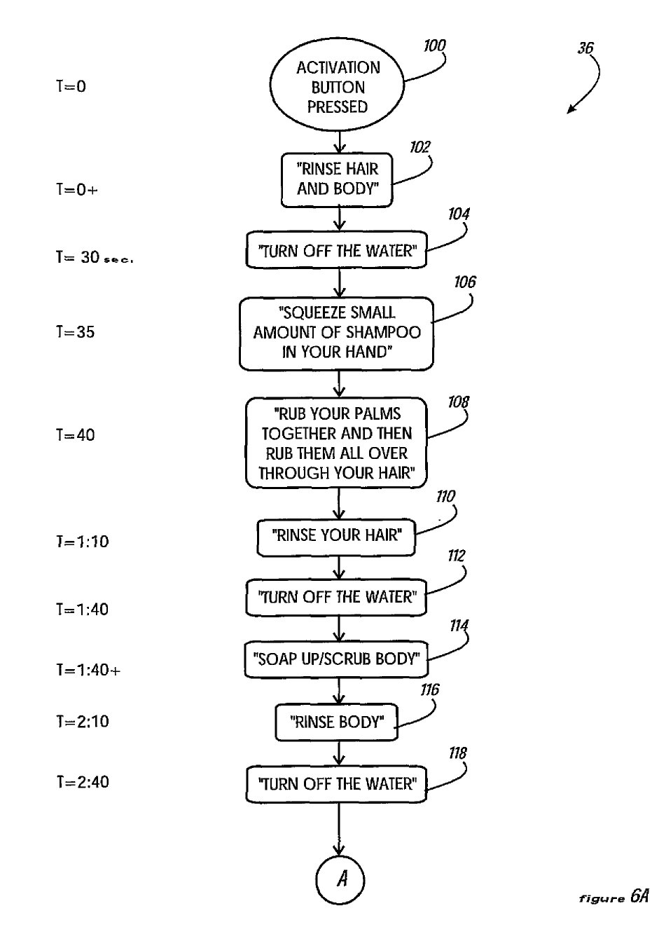

The power supply for the device electronics, such as the batteries 34 shown here. Also, there are mode selection controls 32, which could be touch-sensitive switches and/or a display that is hidden from the child user (i.e. behind the closed cover plate 24). The controls 32 enable the adult/supervisor/administrator to make changes or adjustments to the programming of the device 10, such as to change modes, change type, or change cycle duration. These programming issues are discussed more fully below in connection with FIG. 5. For now, we will first examine another design for the device 10.

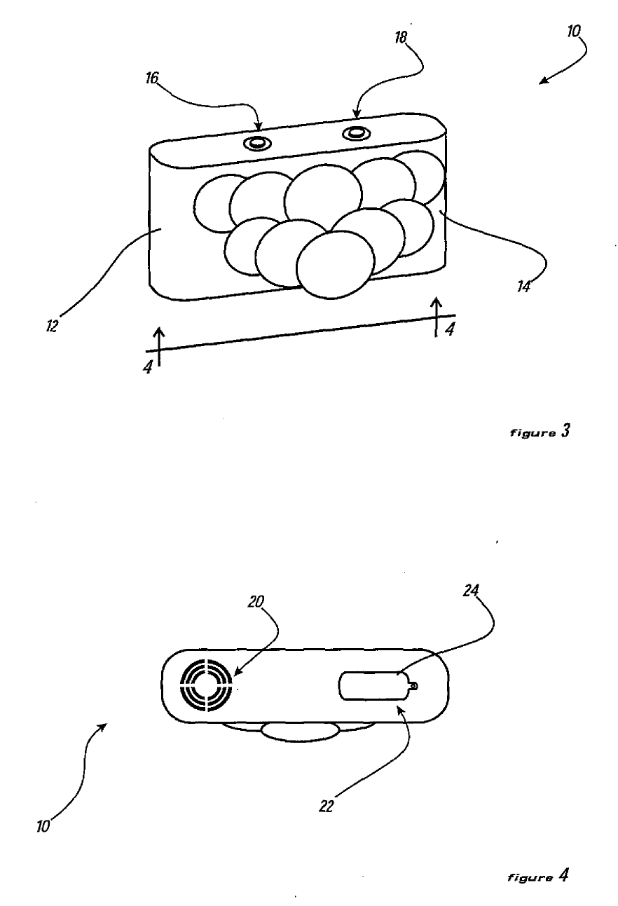

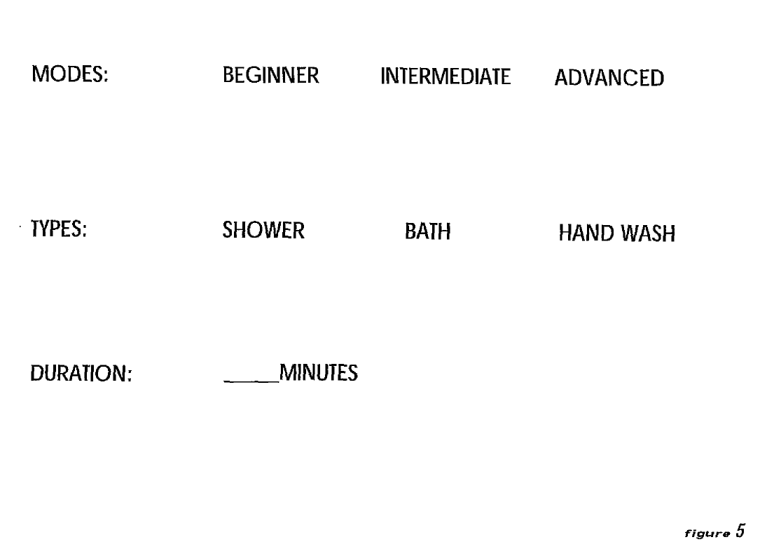

FIG. 3 is a front perspective view of a second preferred embodiment of the shower tutor device 10 of the present invention. This version of the device 10 is shaped like it has a pile of soap bubbles on its face 14. The first and second activation buttons 16, 18 are located atop the housing 12 for convenient depression by the child user. As shown in the bottom view of the device 10 depicted in FIG. 4, the control compartment 22 is located behind a cover plate 24 that is secured in place by a single screw on the outside (and a latch engaging on the inside).

The speaker grill 20 is also water-resistant and is located on the bottom surface of the housing 12. In functional respect, the device depicted in FIGS. 3 and 4 is identical to the device of FIGS. 1 and 2. Now turning to the table of FIG. 5, we can examine the programming options available to the parent of the child user of the device.

FIG. 5 depicts the administrative user control features and settings of the device of the present invention. There could be three mode options selectable by the administrative user (i.e. parent)—beginner, intermediate and advanced. The beginner mode would tend to provide detailed instruction to the least experienced child talking his or her first solo shower—this might be in the 3-6 age range, depending upon the child's individual development. Intermediate and advanced modes would provide less detailed tutoring, and would tend to provide more of a shower timer function (particularly in the advanced mode), where the child is very experienced with taking showers and simply needs a reminder regarding how long to keep the water running.

The type selection would enable the administrative user to configure the device for prompting showering steps, bathing steps, or even hand washing steps. This would provide the widest applicability for the device into the most usage scenarios. Finally, the administrative user may wish to program the device to run the selected mode for a particular number of minutes. For example, the beginner mode could be set for 4 minutes, or it could be set for 8 minutes. In this way, for example, the child user could be gradually urged to shorten the shower period as experience and comfort level increases.

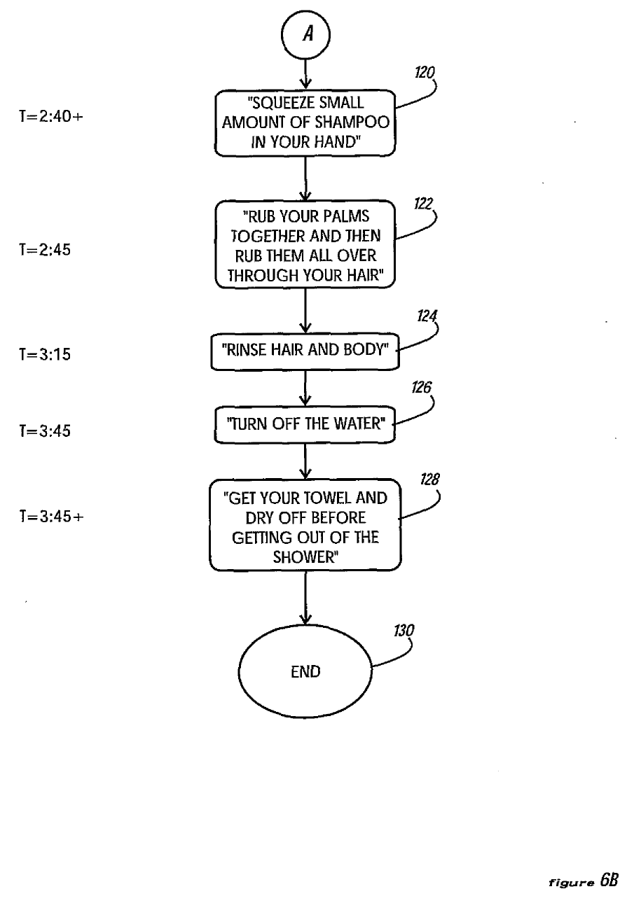

FIGS. 6A and 6B depict one of the preferred shower prompting methods of the present invention. In this example, the prompting method for the beginning level 36 is depicted. Of course, steps might be adjusted, added or removed, depending upon the mode and type of sequence that is being tutored/prompted. The elapsed time is provided at the left of the flowchart as an example only; as discussed above in connection with FIG. 5, the administrative user can change the program run time, which would either manually or automatically change the individual time segments for each prompt.

When the proper activation button is pressed or touched 100, the device will audibly prompt the child user to rinse their hair and body 102. In another sequence, the user might first be prompted to turn on the water, however that may lead to complications if the desired water temperature is not reached in a predictable amount of time.

Next, after thirty seconds, the device will audibly and possibly visually prompt the user to turn off the water 104, and then to squeeze a small amount of shampoo into their hand 106. The user is prompted to rub their palms together and then through their hair until it is sudsy 108. The device will then prompt to turn on the water and rinse the shampoo out of the hair 110.

In the intermediate or advanced modes, the previous method steps might simply be summarized with four steps/prompts: “rinse hair and body, “turn off water,” “shampoo hair,” and “rinse off shampoo.”

The “turn off water” prompt 112 is next followed by a prompt to soap up and/or scrub their body 114. The “rinse” 116 prompt is next followed by the obligatory “turn off the water” prompt 118.

Steps 120-126 are essentially a repeat of steps 106-112 (the first shampoo cycle). Finally, the user will be audibly and possibly visually prompted to get their towel and to dry off before getting out of the shower 128. This is the end 130 of the beginner prompting method.

As mentioned above, it is expected that steps would be consolidated the more advanced the user's hygiene skills. Also, for the bathing or hand washing modes, a similar approach would be taken, but of course with the content of the actual prompts being somewhat different.

Those skilled in the art will appreciate that various adaptations and modifications of the just-described preferred embodiment can be configured without departing from the scope and spirit of the invention. Therefore, it is to be understood that within the scope of the appended claims, the invention may be practiced other than as specifically described herein.

What is claimed is:

1. A method for a human to wash one or more body parts, comprising the steps of:
utilizing a water-resistant electronic device equipped with a sound-generating element,
selecting a desired operational mode from a group of available operational modes; and
executing said operational mode by activating a touch-sensitive switch disposed on said electronic device, the operational mode comprising the generating and issuance of audible prompts on a timed basis to guide the human in the steps of washing the body parts.

2. The method of claim 1, wherein said executing comprises said device audibly prompting the human to turn on water and turn off water.

3. The method of claim 2, wherein said executing comprises said device audibly prompting the human to apply cleanser to, and rinse the applied cleanser off of the one or more body parts.

4. The method of claim 3, wherein said executing comprises each said audible prompting being issued according to a pre-determined time-based schedule.

5. The method of claim 1, wherein said electronic device is further equipped with a visual prompt generating element, and said executing step further comprises issuance of visual prompts on said timed basis.

6. The method of claim 2, wherein said executing further comprises said device presenting said prompting with said visual prompt generating element.

7. The method of claim 3, wherein said executing further comprises said device presenting said prompting with said visual prompt generating element.

8. The method of Clam 4, wherein said executing further comprises said device presenting said prompting with said visual prompt generating element.

9. A device for providing audible and visual prompts to the user, comprising:
a water-resistant housing;
a sound-generating element associated with said housing to emit audible sounds from said housing;
a visual prompt generating element for generating prompts that are perceptible to human vision;
a computing device contained within said water-resistant housing, said computing device configured to generate data prompts for conversion by said sound and visual prompt generating elements into audible and visual messages, said data prompts content comprising prompts to guide a human in the steps of washing his or her body parts; and
an power supply contained within said housing and connected to said computing device.

10. The device of claim 9, wherein said computing device is further configured to generate said prompts at a predetermined time sequence.

11. The device of claim 10, further comprising an actuating pad dispersed on said housing, wherein said computing device commences generating said data prompts and sound messages responsive to a user touch-activating said actuating pad.

12. The device of claim 11, further comprising a second said actuating pad dispersed on said housing, wherein touch-activating said actuating pad triggers said computing device to generate a first set of said data prompts and sound messages and touch-activating said second actuating pad triggers said computing device to generate a second set of said data prompts and audible and visual messages.

13. The device of claim 12, wherein said predetermined time sequence is user-programmable.

14. The device of claim 13, wherein said housing defines a face, said having a plurality of openings through which said sound-generating element can broadcast said sounds, said plurality of openings arranged to simulate a human smile.

15. A device for aiding humans in washing one or more body parts, comprising:
a water-resistant housing having a control compartment contained therein;
a sound-generating element associated with said housing to emit audible sounds from said housing;
a visual cue-generating element associated with said housing to emit visual prompts displayed outside said housing;
a computing device contained within said water-resistant housing, said computing device configured to generate data prompts for conversion by said sound-generating element into sound messages, and visual cue-generating element said data prompts content comprising prompts to guide the human in the steps of washing the body parts; and
an power supply contained within said housing and connected to said computing device.

16. The device of claim 15, wherein said computing device is further configured to generate said prompts at a predetermined time sequence.

17. The device of claim 16, wherein said predetermined time sequence is selectively user-programmable.

18. The device of claim 17, further comprising an actuating pad dispersed on said housing, wherein said computing device commences generating said data prompts and audible and visual messages responsive to a user touch-activating said actuating pad.

19. The device of claim 18, further comprising a second said actuating pad dispersed on said housing, wherein touch-activating said actuating pad triggers said computing device to generate a first set of said data prompts and audible and visual and touch-activating said second actuating pad triggers said computing device to generate a second set of said data prompts and sound messages.

20. The method of claim 1, wherein said executing further comprises generating and issuance of audible prompts on a timed basis to guide the human in the steps of washing the body parts, wherein following said steps will reduce water consumption and increase cleaning effectiveness.
